(19) United States
(12) Patent Application Publication
(10) Pub. No.: US 2010/0098504 A1
(43) Pub. Date: Apr. 22, 2010

(54) END MILLING CUTTER WITH DIFFERENT CUTTING EDGES

(75) Inventor: Josef Gießler, Muhlenbach (DE)

Correspondence Address: DRINKER BIDDLE & REATH (DC), 1500 K STREET, N.W., SUITE 1100, WASHINGTON, DC, 20005-1209, US

(73) Assignee: Sandvik Intellectual Property AB, Sandviken (SE)

(21) Appl. No.: 12/448,068

(22) PCT Filed: Nov. 27, 2007
(86) PCT No.: PCT/EP2007/062855

§ 371 Date: Dec. 4, 2009

(30) Foreign Application Priority Data
Dec. 8, 2006 (DE) 10 2006 058 258.6

(51) Int. Cl. B23C 5/10

(52) U.S. Cl. 407/53; 407/61

(57) ABSTRACT

The invention concerns an end milling cutter having a plurality of end cutting edges (10, 20) of which at least a first (10) extends to the axis (30) of the milling cutter. To provide an end milling cutter which allows markedly higher axial feed movements and nonetheless leaves behind relatively smooth surfaces in the normal lateral advance movement of the milling cutter at its end, it is proposed in accordance with the invention that the milling cutter has at least one further second end cutting edge (20) different from the first end cutting edge (10), wherein the axial position and configuration of the first cutting edge (10) and the second cutting edge (20) are so provided that, when the rotating milling cutter axially passes into a workpiece, a radially inner region (a) cuts only by the first cutting edge (10) from the axis (30) of the milling cutter to a first radius (rᵢ) which is smaller than the nominal radius and larger than a radially inner radius of the second cutting edge, and in a second region (b) which is between the radius rᵢ and a larger radius rₐ which at a maximum can assume the value of the nominal radius (R) of the milling cutter only the second cutting edge (20) cuts.

The present invention concerns an end milling cutter having a plurality of cutting edges of which at least a first one extends as far as the axis of the milling cutter, as set forth in the classifying portion of claim 1.

Corresponding end milling cutters which are also referred to as shank cutters have long been known. With such cutters, in the normal feed movement of the end milling cutter in operation, which movement is perpendicular to the axis, the end cutting edges serve to produce a more or less smooth surface, on the side of the workpiece that is towards the end of the cutter. Shank cutters or end milling cutters in which at least one cutting edge extends to the center or to the axis of the cutter can within certain limits also be moved into a workpiece, with an axial feed movement or a combined axial and lateral feed movement. It will be noted however that the axial feed movement is generally reserved for drills or boring tools which have cutting edges specifically designed for that axial feed movement whereas the end cutting edges of an end milling cutter serve primarily to smooth the surfaces which remain under the end cutting edges, during the normal horizontal feed movement of the milling cutter.

That requirement entails limitations which do not allow the end of a shank milling cutter or end milling cutter to be designed similarly to that of a boring tool or drill in order in that way better to permit axial feed movements. The requirement for producing at least approximately smooth surfaces along the ends of an end milling cutter rather results in the end cutting edges being of a configuration which is by far from being optimum, in terms of axial feed movements.

In comparison with that state of the art, the object of the present invention is to provide an end milling cutter which allows markedly higher axial feed movements and which nonetheless, in the normal lateral feed movement (occurring perpendicularly to the axis) of the milling cutter, leaves relatively smooth surfaces at its end.

That object is attained in that the milling cutter has at least one further second end cutting edge different from the first end cutting edge, wherein the axial position and configuration of the first cutting edge and also the second cutting edge are so provided that, when the rotating milling cutter axially passes into a workpiece, within a radially inner region from the axis of the milling cutter to a first radius rᵢ only the first cutting edge cuts, wherein the radius rᵢ is smaller than the nominal radius of the end milling cutter, and in a second, radially adjoining region only the second cutting edge cuts, and more specifically which is between the radially inner radius rᵢ and a larger radius rₐ which at a maximum can assume the value of the nominal radius R of the milling cutter.

That division of working regions for the first cutting edge and the second cutting edge make it possible for the first cutting edge to be of a configuration primarily for an effective axial feed movement while the second cutting edge is admittedly also not intended as far as possible to impede an axial feed movement but at the same time, in a lateral feed movement, is also intended to produce a surface which is as smooth as possible on the workpiece, wherein that mode of operation is in turn not impeded or adversely affected by the first cutting edge and in accordance with preferred embodiments is even assisted.

In accordance with a first embodiment of the invention the outer radius rₐ to which the second cutting edge cuts solely in a radial direction is smaller than the nominal radius R of the milling cutter, wherein the region between the radius rₐ and the nominal radius R, when the milling cutter axially passes into a workpiece, is cut substantially equally by both cutting edges.

It will be appreciated that, insofar as reference is made to radially inner and adjoining radial regions or a radially outer region, that refers to the reference system of the milling cutter and, insofar as reference is made to cutting in those regions, that involves consideration of a solely axial movement of the milling cutter. Otherwise, in the event of an exclusively lateral feed movement, the radially outer regions of the cutting edges also cut the material in the same region, over which the radially inner regions of the cutting edges are also guided in accordance with a corresponding feed.

In accordance with an embodiment of the present invention the radially outer regions of the first and the second cutting edges are at the same time the cutting edge regions which axially project the furthest and they extend almost perpendicularly to the axis or at an angle which differs only little from the 90° angle relative to the axis. Those cutting edge portions can also involve a slight curvature, the radius of which at least approximately corresponds to the nominal radius of the milling cutter. The radially inner cutting edge portions can in comparison involve a greater inclination with respect to a plane perpendicular to the axis of the milling cutter and in particular can also be provided with projecting tips which in the axial direction are either set back axially just as far as the radially outer cutting edge portions or only slightly in relation to those radially outer regions, that is to say typically less than 1 mm.

In accordance with another embodiment of the present invention at least one further first cutting edge is arranged symmetrically relative to the axis of the milling cutter, in relation to the first cutting edge. The first cutting edges in that case are identical to each other and are only displaced relative to each other in the peripheral direction, wherein the angular spacings derive from a complete circle, divided by the number of the first cutting edges.

In yet a further embodiment of the invention there are provided a plurality of second cutting edges which are in turn are arranged symmetrically, that is to say at angular spacings which are the same as each other, relative to the milling cutter axis.

Desirably the number of first cutting edges and second cutting edges is respectively identical, in which case then, in accordance with a further embodiment, the first cutting edges and the second cutting edges are arranged alternately in the peripheral direction of the milling cutter. It will be noted in that case however that the angular spacings between the immediately successive cutting edges can vary, that is to say the alternating first and second cutting edges involve different angular spacings, relative to respectively adjacent cutting edges, in which case, as viewed in the direction of rotation, the angle of a first cutting edge relative to the next second cutting edge is greater than the angle from said second cutting edge to the next following first cutting edge.

If the first cutting edges extend into the center of the milling cutter, the second cutting edges at the center of the milling cutter are cut out within an inner radius r₄ so that in the cut-out region of the second cutting edges, in the event of an axial feed, exclusively the first cutting edges can cut material.

In accordance with an embodiment of the invention the first cutting edges can be composed of a plurality of portions which include different positive or negative angles with a perpendicular to the axis of the milling cutter, and in particular the first cutting edge, starting from the axis of the milling cutter, is of the following configuration:

A first portion is angled forwardly, accordingly encloses a negative angle α₁ with a plane perpendicular to the axis and extends in a radial direction to a radius r₁. A second portion adjoining that first portion is angled back in the axial direction and thus includes a positive angle α₂ with the plane perpendicular to the axis. The second portion extends between the radii r₁ and r₂. A third portion adjoining the second portion in the radial direction again includes a negative angle α₃ with the plane perpendicular to the axis, wherein that portion extends from a radius r₂ to a radius r₃ which is at most equal to the nominal radius R of the milling cutter, in which respect it will be noted however that in accordance with an embodiment the radius r₃ is smaller than the nominal radius R so that the first cutting edge in accordance with this embodiment has an optional fourth outer portion which extends from the radius r₃ to the nominal radius R and includes at most a small angle of between +2° and −2° with the plane perpendicular to the axis.

As already mentioned, in accordance with an embodiment, the second cutting edge is cut out to an inner radius r₄ and thus begins at the radius rᵢ from which it extends to an outer radius r₅ which at most corresponds to the nominal radius R, in which respect here too there is the option that, when the outer radius r₅ is smaller than the nominal radius R, the second cutting edge also has a further outer portion extending from the outer radius r₅ to the nominal radius R, wherein that outer portion includes an angle α₅ of between +2° and −2° with the plane perpendicular to the axis. Desirably the respective optionally provided outer portions of the first cutting edge and the second cutting edge are at the same axial height and they are also overall the axially furthest projecting regions of the first and second cutting edges. The radial length and any curvature of the radially outer portions of the first and second cutting edges are also desirably identical. In addition any inclination in relation to a plane perpendicular to the milling cutter axis could be respectively identical for the outer portions of the first and second cutting edges, wherein the corresponding angles or also the radii of curvature of the radially outer portions of the first and second cutting edges can also involve minor deviations from each other. The last-mentioned outer portions of the first and second cutting edges which also axially project the furthest, in the lateral feed movement of the milling cutter, produce the smooth workpiece surface that is towards the end of the milling cutter, and they are thus effectively planing cutting edges. It will be appreciated in that respect that the maximum lateral feed of the milling cutter per cutting edge should at most correspond to the radial length of those outer cutting edge portions.

In regard to the angles of the various portions of the cutting edges, in accordance with an embodiment of the invention the angle α₄ should be smaller in magnitude than the angle α₃, wherein the optionally provided, radially outer portion of the first cutting edge is at the same axial height as the radially outer portion of the second cutting edge and wherein the cutting edge portions which are of the angle α₃ and α₄ respectively adjoin the radially inner ends of the radially outer portions. That effectively provides that the inner portion of the second cutting edge which includes the positive angle α₄ with a plane perpendicular to the axis extends axially beyond the cutting edge portion of the first cutting edge, that is approximately in the same radial region and is inclined at the negative angle α₃ with respect to a perpendicular to the axis of the milling cutter.

Radially inner cutting edge portions which have a relatively greater inclination with respect to a plane perpendicular to the milling cutter axis, in accordance with an embodiment, are set back with respect to radially outer cutting edge portions in the axial direction or extend at most to the axial position of the outer portions without projecting beyond them. That ensures that those inclined cutting edge portions do not have a detrimental influence on the production of a smooth workpiece surface on the end of the milling cutter.

Preferably such radially inner cutting edge portions which are inclined more greatly with respect to a plane perpendicular to the milling cutter axis, in comparison with the outer portions, should involve a inclination of a maximum of 30°, preferably a maximum of 20° and a minimum of 5°, wherein selectively also at least a part of the inner cutting edge portions can extend without an inclination worth mentioning, that is to say parallel or at less than 2° relative to that plane.

Radially inner cutting edge portions which have a relatively greater inclination with respect to a plane perpendicular to the milling cutter axis can optionally define at least one tip which can optionally be rounded off.

The tip formed by inner cutting edge portions which are at a relatively greater inclination with respect to a plane perpendicular to the milling cutter axis, in accordance with an embodiment, is set back in the axial direction with respect to radially outer portions by less than 2 mm, preferably by less than 1 mm and in particular between 0.1 and 0.5 mm.

In accordance with an embodiment the optionally rounded tip is formed exclusively by cutting edge portions of the first cutting edge.

Further advantages, features and possible uses of the present invention will be apparent from the description hereinafter of a preferred embodiment and the accompanying Figures in which:

FIG. 1 shows a perspective view of an end milling cutter according to the invention,

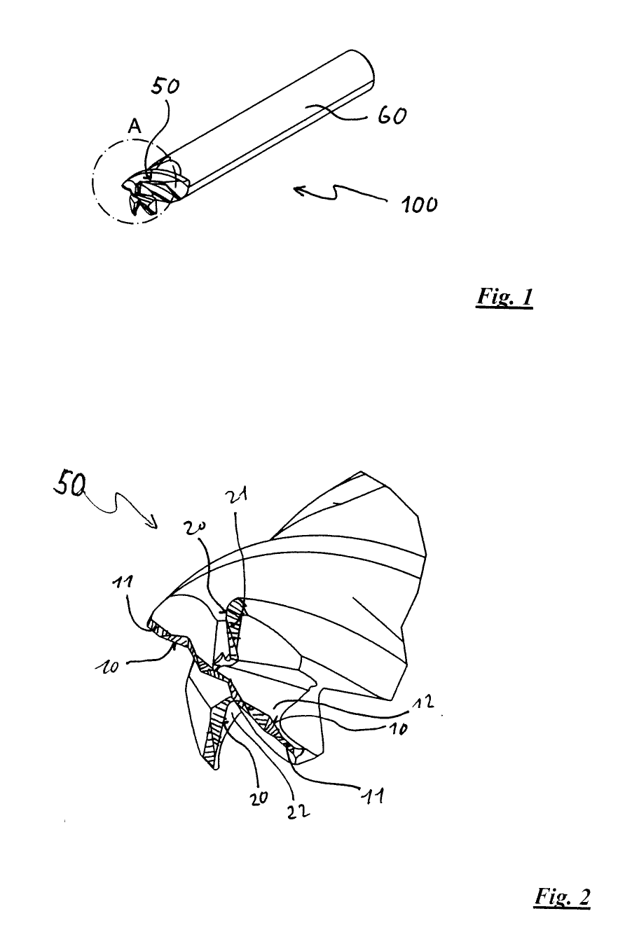

FIG. 2 shows a view of a portion from FIG. 1 on an enlarged scale, and

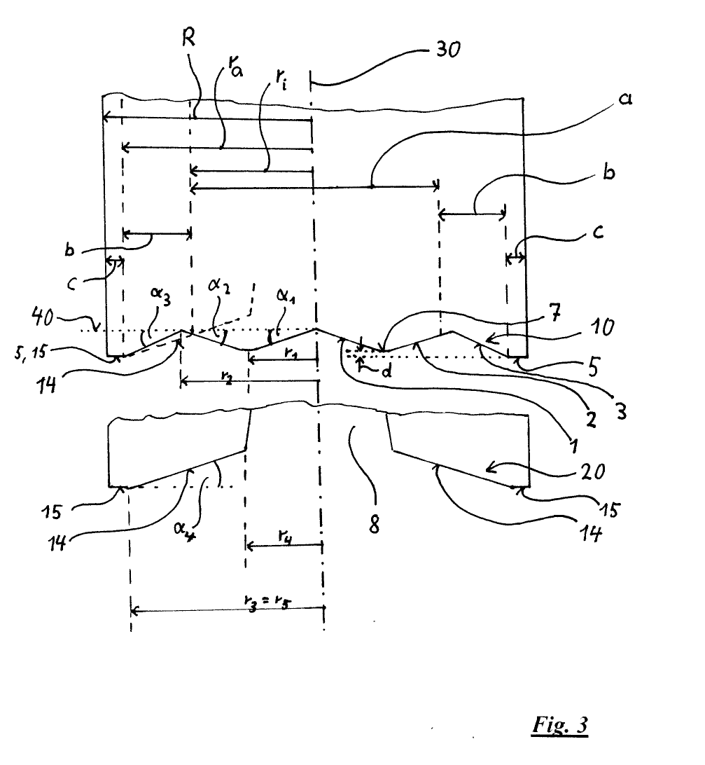

FIG. 3 shows the cutting edge configuration of the first and second cutting edges which are shown in axially mutually displaced relationship in the Figure.

FIG. 1 shows an end milling cutter which is generally identified by reference 100 and which comprises a clamping end or shank 60 and a cutting edge part 50. The cutting edge part is shown once again on an enlarged scale in FIG. 2 so that the details of that cutting edge part can be better seen. In the present case it is possible to see a cutting edge part 50 having a total of four cutting edges of which two cutting edges are first cutting edges 10 and two cutting edges are second cutting edges 20, wherein the first cutting edges 10 are disposed in mutually diametrally opposite paired relationship and likewise also the second cutting edges 20 are disposed in mutually diametrally opposite paired relationship. In order to more clearly show the cutting edge configuration the relief surfaces 11 and 21 respectively adjoining the cutting edges are shown hatched while the true rakes 12 and 22 respectively which are in front of the cutting edges are not hatched, in which respect in this perspective view it is only possible to see two of the true rakes and the cutting edges are each in the form of intersection lines of the relief surfaces 11 and 21 with the respective true rakes 12 and 22 respectively.

FIG. 3 shows a side view and a sectional view respectively illustrating the configuration of the cutting edges 10 and 20, the upper part of FIG. 3 corresponding to an axial section through the milling cutter, which is in the plane of the first cutting edges 10, while the lower part in FIG. 3 shows an axial section which is turned approximately through 90° with respect to the section plane of the upper part and which shows the two mutually diametrally opposite second cutting edges 20. In order more clearly to show the various cutting edge configurations, the two sections are shown in axially displaced relationship. In addition, for better comparison, the position of a second cutting edge 20 is shown in broken line in a projection onto the first cutting edge 10 in the upper part on the left-hand side so that it is then clearly apparent that the two outer cutting edge portions 5 of the first cutting edge 10 and 15 of the second cutting edge 20 coincide.

In the sense used herein the terms “first cutting edge” and “second cutting edge” respectively refer to a half of the cutting edges which can be seen at the top and the bottom in the Figure, that is to say the first cutting edge begins at the center of an axis 30 of the milling cutter with a first cutting edge portion 1 which in accordance with the definition adopted here includes a negative angle α₁ with a plane 40 perpendicular to the axis 30 of the milling cutter. That first radially inner portion 1 of the first cutting edge 10 is adjoined by a second portion 2 of the first cutting edge 10, which extends inclinedly at a positive angle α₂ relative to the plane 40. Both cutting edge portions 1 and 2 together form a shallow roof shape with a tip 7 which can possibly also be rounded with a small radius. Once again, adjoining the radially outer end of the second portion 2 is a third portion 3 of the first cutting edge 10, which again extends inclinedly at a negative angle α₃ relative to the plane 40 and adjoining the radially outer end of that portion 3 there is also the radially outer portion 5 which extends approximately parallel to the plane 40 or inclinedly at an only small angle of less than ±2° relative to the plane 40 and which can also involve a curvature, the corresponding radius of curvature corresponding at least to the nominal radius R of the milling cutter.

In mirror image relationship with the first cutting edge 10 just described above, it is possible to see a further first cutting edge 10 on the other side of the axis 30.

The second cutting edges 20 can be seen in the lower part of FIG. 3, where those cutting edges are shown in axially displaced relationship with the first cutting edge, but in actual fact are also disposed axially in the region of the first cutting edges, more specifically in such a way that the respectively outer portions 5 and 15 are at the same axial height.

The second cutting edges 20 are cut out in the center, that is to say in the proximity of the axis 30 of the milling cutter. Those cut-outs 8 ensure that a sufficient chip space is available in front of the radially inner cutting edge portions 1 of the first cutting edges. Starting from the axis 30 of the milling cutter, the second cutting edge 20 begins only at a radius rᵢ which approximately corresponds to the radial length r₁ of the first portion 1 of the first cutting edge but which can also be greater or somewhat smaller. The first portion 14 of the second cutting edge 20, which extends from there radially outwardly, extends at a negative angle α₄ relative to the plane 40 representing a plane perpendicular to the milling cutter axis 30. That is outwardly adjoined by the above-mentioned portion 15 which in this embodiment is identical in terms of length configuration, inclination and axial position to the outer portion 5 of the inner cutting edge 10. That can be seen in particular in the top left part of the view in FIG. 3 where the cutting edge portion 14 of the second cutting edge is shown in broken lines in the axially correct position and projected into the plane of the first cutting edge 10 and where the portions 5 and 15 coincide.

As can be seen however by reference to the configuration of the broken-line portion 14 in comparison with the portion 3 in the upper part of FIG. 3, the portion 14 of the second cutting edge is inclined through an angle α₄ relative to the axis 40, which is less than the angle α₃ by which the portion 3 of the first cutting edge 10 is inclined relative to that plane 40. That signifies that the portion 14 extends axially in front of the portion 3 and thus cuts or machines regions of the workpiece, which can no longer be engaged by the correspondingly axially set-back portion 3 of the first cutting edge 10. As can be further seen in the top left part of FIG. 3 the broken line 14 which represents the second cutting edge 20, in this projection, intersects the second portion 2 of the second cutting edge at a radius r₁, measured from the axis 30 of the milling cutter. As a result, that gives three different regions, namely a radially inner region a corresponding to the radius rᵢ at which the portion 14 shown in broken line of the second cutting edge 20 intersects the second portion 2 of the first cutting edge 10, a second region b which surrounds the region a in a ring shape and which is between that radius r₁ and a further radius rₐ and which at the same time marks the radially outer end of the cutting edge portion 14 of the second cutting edge and the cutting edge portion 3 of the first cutting edge, and a region c which in turn surrounds the region b in a ring shape, with a radial dimension corresponding to the length of the outer portions 5 and 15 of the cutting edges 10 and 20 respectively.

Accordingly, upon an axial feed of the milling cutter, the region a is cut exclusively by the cutting edges 1 and 2 approximately as far as the radius rᵢ, in the region b between rᵢ and rₐ the cutting work is implemented virtually exclusively by the portion 14 of the second cutting edge 20 and in the portion 10 the cutting action is effected equally by the outer cutting edge portions 5 of the first cutting edge 10 and 15 of the second cutting edge 20 respectively.

In this respect the axial positions and angles of inclination of the cutting edge portions 1 and 2 are such that the tip 7 which is formed between those cutting edge portions and which can possibly be flattened off or rounded is axially set back slightly with respect to the radially outer portions 5 and 15, more specifically typically by a spacing of not more than 2 mm, preferably less than 1 mm. Under some circumstances that spacing can be reduced to the value 0, but the tip 7 should if possible not project axially with respect to the outer portions 5, 15.

As can be seen by reference to that cutting edge geometry the symmetrically arranged, roof-shaped tips 7 of the two cutting edges 10 provide for centering in the event of an axial feed movement as the adjoining cutting edge portions extend inclinedly with respect to a plane perpendicular to the axis of the milling cutter and are of a symmetrical configuration so that any reaction forces which are exerted on the milling cutter by the engagement of the cutting edge portions 1, 2 in question with the workpiece compensate from each other, wherein the angles α₁ and α₂ and the respective radial lengths of the portions 1 and 2 are preferably so selected that the radial forces produced by the engagement of the cutting edge portions 1 and 2 respectively with the workpiece already compensate each other for each of the cutting edges 10 and, insofar as such compensation is not already achieved on one side, that is achieved at any event by virtue of the symmetrical configuration and arrangement of the two cutting edges 10 and possibly further cutting edges 10.

The two cutting edge portions 14 of the second cutting edges 20 are also arranged in mirror image relationship and symmetrically relative to each other so that, upon engagement of those cutting edge portions with the workpiece, the reaction forces acting on those cutting edges in the radial direction also compensate each other.

In that way, a good centering action and guidance effect is achieved even upon an axial feed movement of such an end milling cutter so that the milling cutter does not laterally deviate in any direction. At the same time at least the first cutting edges involve a cutting edge configuration which in principle is modeled on the cutting edge configuration of some boring tools or drills, even if boring tool or drill cutting edges with corresponding roof-shaped cutting edge configurations are generally not arranged symmetrically relative to the axis of a boring tool or drill. Due to the cut-outs 8 of the second cutting edges which do not extend as far as the center and due to the first cutting edges being taken to the center, there is on the one hand sufficient chip space available while on the other hand cutting takes place also as far as the center of the milling cutter, which considerably facilitates the axial feed movement.

For the purposes of the original disclosure it is pointed out that all features as can be seen by a man skilled in the art from the present description, the drawings and the claims, even if they are described in specific terms only in connection with certain other features, can be combined both individually and also in any combinations with others of the features or groups of features disclosed here insofar as that has not been expressly excluded or technical aspects make such combinations impossible or meaningless. A comprehensive explicit representation of all conceivable combinations of features is dispensed with here only for the sake of brevity and readability of the description.

1. An end milling cutter having a plurality of end cutting edges (10, 20) of which at least a first (10) extends to the axis (30) of the milling cutter, wherein the milling cutter has at least one further second end cutting edge (20) different from the first end cutting edge (10), wherein the axial position and configuration of the first cutting edge (10) and the second cutting edge (20) are so provided that, when the rotating milling cutter axially passes into a workpiece, a radially inner region (a) cuts only by the first cutting edge (10) from the axis (30) of the milling cutter to a first radius (rᵢ) which is smaller than the nominal radius and larger than a radially inner radius of the second cutting edge, and in a second region (b) which is between the radius rᵢ and a larger radius ra which at a maximum can assume the value of the nominal radius (R) of the milling cutter only the second cutting edge (20) cuts.

2. An end milling cutter as set forth in claim 1 wherein the outer radius (rₐ) to which the second cutting edge (20) cuts is smaller than the nominal radius (R) of the milling cutter, wherein the region (c) between the radius (rₐ) and the nominal radius (R), when the milling cutter axially passes into a workpiece, is cut substantially equally by both cutting edges (10, 20).

3. An end milling cutter as set forth in claim 1 wherein a plurality of first cutting edges (10) are arranged symmetrically with respect to the milling cutter axis.

4. An end milling cutter as set forth in claim 1 wherein a plurality of second cutting edges (20) are arranged symmetrically with respect to the milling cutter axis.

5. An end milling cutter as set forth in claim 1 wherein the first (10) and second (20) cutting edges are arranged alternately in the peripheral direction of the milling cutter.

6. An end milling cutter as set forth in claim 1 wherein the second cutting edges (20) are cut out in the center of the milling cutter within an inner radius (rᵢ).

7. An end milling cutter as set forth in claim 1 wherein the alternating first and second cutting edges are at different angular spacings with respect to respectively adjacent cutting edges, wherein, viewed in the direction of rotation, the angle from a first cutting edge (10) to the second cutting edge (20) is larger than the angle, viewed in the direction of rotation, from a second cutting edge (20) to a first cutting edge (10).

8. An end milling cutter as set forth in claim 1 wherein the first cutting edge comprises a plurality of cutting edge portions (1, 2, 3, 5) which are inclined relative to the axis, wherein said portions, starting from the axis (30) of the milling cutter, are of the following configuration:
A first portion is angled forwardly and accordingly includes a negative angle (α₁) with a plane perpendicular to the axis, a second portion (2) which adjoins the first portion (1) and which is angled back in the axial direction and thus includes a positive angle (α₂) with a plane perpendicular to the axis, a third portion (3) which adjoins the second portion (2) and includes a negative angle (α₃) with the plane perpendicular to the axis and which extends to a radius (r₂) which at most is equal to the nominal radius (R) of the milling cutter and optionally if the radius (r₂) is smaller than (R) a fourth outer portion (5) which extends to the nominal radius (R) and which includes an angle of between +2° and −2° with the plane perpendicular to the axis.

9. An end milling cutter as set forth in claim 1 wherein the second cutting edge (20) has an inner portion (11) which extends from an inner radius (rᵢ) to an outer radius (rₐ) which corresponds at most to the nominal radius and if the outer radius (rₐ) is smaller than the nominal radius (R) has a second outer portion (6) which extends from the outer radius (rₐ) to the nominal radius (R) and which includes an angle α₅ between +2° and −2° with the plane perpendicular to the axis.

10. An end milling cutter as set forth claim 8 wherein the angle α₄ is smaller in magnitude than the angle α3 and the optionally present radially outer portion (4) of the first cutting edge (10) is at the same axial height as the radially outer portion (12) of the second cutting edge (20), wherein the radially outer portions (4, 12) are substantially at the same axial height.

11. An end milling cutter as set forth in claim 1 wherein the optionally present radially outer portions (5, 15) in a projection of the second cutting edge (20) onto the first cutting edge (10) are at the same axial height above one another, wherein the radius (r₂) is equal to the outer radius (rₐ), the radially inner portion (11) of the second cutting edge (20) is axially in front of the third portion (3) of the inner cutting edge and the inner portion (11) of the second cutting edge (20) intersects the second portion (2) at the spacing of the ends thereof.

12. An end milling cutter as set forth in claim 1 wherein radially inner cutting edge portions (1, 2, 3, 14) which have a relatively greater inclination with respect to a plane (40) perpendicular to the milling cutter axis (30) are set back in the axial direction with respect to radially outer cutting edge portions (5, 15) or extend at most to the axial position of the outer portions without projecting beyond same.

13. An end milling cutter as set forth in claim 1 wherein radially inner cutting edge portions (1, 2, 3, 14) have an inclination of a maximum of 30°, preferably a maximum of 20° and a minimum of 5°, with respect to a plane (40) perpendicular to the milling cutter axis.

14. An end milling cutter as set forth in claim 1 wherein radially inner cutting edge portions (1, 2, 3, 14) which have a relatively greater inclination with respect to a plane (40) perpendicular to the milling cutter axis define at least one optionally rounded-off tip (7).

15. An end milling cutter as set forth in claim 14 wherein a tip formed by inner cutting edge portions (1, 2, 3, 14) which have a relatively greater inclination with respect to a plane perpendicular to the milling cutter axis is set back in the axial direction with respect to radially outer portions (5, 15) by less than 2 mm, preferably by less than 1 mm and in particular between 0.1 and 0.5 mm.

16. An end milling cutter as set forth in claim 14 wherein radially inner cutting edge portions (1, 2, 3) which have a relatively greater inclination with respect to a plane perpendicular to the milling cutter axis (30) and define at least one optionally rounded-off tip (7) are exclusively cutting edge portions (1, 2, 3) of the first cutting edge (10).
